(19) United States
(12) Patent Application Publication
(10) Pub. No.: US 2003/0128339 A1
(43) Pub. Date: Jul. 10, 2003

(54) ULTRA-COMPACT ULTRA-HIGH UNIFORMITY PROJECTION LENS FOR PROJECTION DISPLAYS

(76) Inventor: AMJAD I. MALIK, BATTLE GROUND, WA (US)

Correspondence Address: LORIA B. YEADON, HONEYWELL INTERNATIONAL INC., PATENT SERVICES GROUP, P.O. BOX 2245, MORRISTOWN, NJ, 07962-2245, US

(21) Appl. No.: 09/467,126

(22) Filed: Dec. 17, 1999

(51) Int. Cl. G03B 21/00

(52) U.S. Cl. 353/31

(57) ABSTRACT

An apparatus for projecting images onto a projection screen is disclosed. The apparatus incorporates novel features to reduce both cost and size while providing a high level of illumination uniformity at the projection surface. Specifically, the apparatus uses an illumination focusing group for providing a uniform level of light on the image to be projected. The illumination focusing group is designed to make use of lenses unsuitable for use as projection lenses, thus reducing scrap and the attendant cost thereof.

### UNITED STATES GOVERNMENT RIGHTS

The United States Government has acquired certain rights in this invention through Government Contract No. NAS1-20219 awarded by the National Aeronautics and Space Administration.

### BACKGROUND OF THE INVENTION

The present invention relates in general to the field of image projection, and more particularly, to the projection of images on a projection screen.

Without limiting the scope of the invention, its background is described in connection with liquid crystal displays, as an example.

The use of a combination of a light source and one or more lenses to project a small image onto a large screen is generally known in the art. This general method is commonly employed in the design of movie projectors, slide projectors and overhead projectors, as examples. Generally these designs incorporate a light source which illuminates an image printed on a planar object surface, such as a transparent film or similar medium. The light rays coming from the object surface are then focused on a screen or other projection surface by a lens or group of lenses. Generally, the image displayed on the projection surface is significantly larger than the image on the object surface, as the lens group performs both a magnification and a focusing function.

With such an apparatus, it is important that the image projected on the surface have a substantially uniform illumination level. A non-uniform illumination level is manifested in the projected image as overly dark and overly bright regions, making the projected image uncomfortable or difficult for the viewer to read or discern. To address this problem, illumination lenses have been incorporated into the design. These lenses are designed to focus and direct the light onto the object surface with a uniform level of illumination. A more uniform level of illumination at the object surface generally results in a more uniform level of illumination in the image projected on the projection surface.

Unfortunately, the cost of lenses represents a significant portion of the cost of a projection assembly. As such, the addition of illumination lenses to a design can represent a significant cost increase to the projection assembly.

### SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

The present invention is designed to make use of lenses having the same design in both the illumination and projection groups. It is very important that the lenses in the projection group have very high tolerances, so as to avoid distortion or blurring of the projected image. It is less important, however, that the lenses of the illumination group meet the same level of precision. This invention makes use of these facts to reduce the cost of projecting devices incorporating the teaching herein. Specifically, the invention makes use of at least some lenses produced on a common manufacturing line in both the illumination and projecting groups.

This invention allows the tolerances for the lens manufacturing line to be relaxed. The lenses produced are tested after manufacture and sorted according to quality. Lenses meeting the higher tolerances necessary for image projection are incorporated into the projection group, while lenses not conforming to projection tolerances are used in the illumination group, thus saving cost.

The novel features of the present invention will become apparent to those of skill in the art upon examination of the following detailed description of the invention or can be learned by practice of the present invention. It should be understood, however, that the detailed description of the invention and the specific examples presented, while indicating certain embodiments of the present invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 is a drawing of a transmissive projection device incorporating the present invention;

FIG. 2 is a drawing of a reflective projection device incorporating the present invention;

FIG. 3 is a drawing of a projection unit incorporating a light source, a projection device and a projection screen in accordance with the present invention; and

FIG. 4 is a drawing of one embodiment of a compact polarizer in accordance with the present invention.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention and do not delimit the scope of the invention.

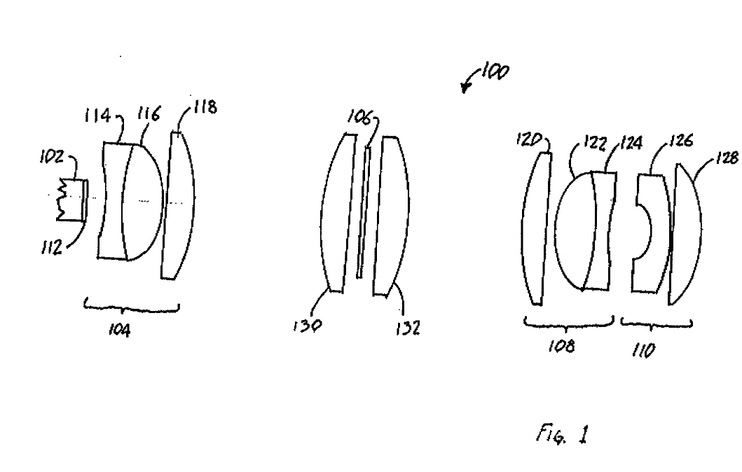

The general features of a projection device designed according to the present invention are shown in FIG. 1. A projection device, generally designated 100, comprises a rear illumination focusing group 104, an object surface 106, a first projection focusing group 108, and a second projection focusing group 110. In operation, the illumination focusing group 104 receives light from a light source, here designated 102. The projection device 100 is shown in FIG. 1 having a generally linear orientation for clarity, but there is nothing in the nature of the invention necessitating such a layout. The projection device 100 could be constructed to have an “L” or an “U” shape, for example, through the use of mirrors, prisms or other devices used for changing the direction of light rays without departing from the invention.

In a preferred embodiment, the illumination focusing group 104 focuses the light received from the light source 102 onto the object surface 106 in a uniform, telecentric manner. In various embodiments, the light source 102 could comprise, for example, an aperture lamp, a light pipe or a fiber optic device. One advantage of this design, however, is that no additional optics, such as light pipes or lens arrays, are required to make the light uniform. Conventional designs generally require additional optics, such as lens arrays, for this function. Without the illumination focusing group 104, the object surface 106 would generally be illuminated in a less-uniform manner, owing to imperfections in the light source or sources 102. Non-uniform illumination of the object surface 106 would manifest itself as undesirable light and dark regions in the image projected on a surface.

The illumination focusing group 104 is shown in FIG. 1 as comprising a rear illumination focusing lens 114, an intermediate illumination focusing lens 116 and a front illumination focusing lens 118 as an illustration. Although the illumination focusing group 104 is described in connection with lenses 114, 116 and 118 as shown in FIG. 1, there is no requirement that the illumination focusing elements necessarily comprise the types or number of lenses shown, or that they comprise lenses at all. Any one or more of focusing elements 114, 116 or 118 could alternatively, without departing from the spirit of the invention, be implemented as fresnel lenses, for example, or as curved mirrors or any of the numerous other devices or combination thereof known in the art of focusing light.

After passing through the illumination focusing elements 114, 116, and 118, light passes through a first plano-convex field lens 130 and into the object surface 106. The first piano-convex field lens 130 ensures that the light propagating the object surface 106 is telecentric.

The design shown in FIG. 1 makes use of a transmissive object surface 106 (e.g., film, a slide, a negative, etc.) That is, the light rays falling on the object surface 106 pass through the object plane 106 and into the projection groups 108 and 110. Generally, the object surface 106 will have an image displayed thereon. The object surface 106 can comprise a photographic slide, as an example. In the preferred embodiment, the object plane 106 is a liquid crystal display panel under the control of some electronic apparatus such as a personal computer. In this embodiment, the image on the object surface 106 can be varied by providing different electronic signals to the liquid crystal display panel.

In an embodiment using a liquid crystal display panel as an object surface 106, the light passing through the liquid crystal display panel must be polarized before striking the display panel. This can be accomplished, for example, through the use of a polarized filter in the light path such as is represented by element 112, but any of the devices known in the art of light polarization, for example those disclosed elsewhere in this application, could be employed successfully without departing from the basic invention.

After passing through the object surface 106, the light rays pass through the second plano-concentric field lens 132, the first projection focusing group 108, and the second projection focusing group 110. The focusing groups 108 and 110 project and focus the light rays passing through the object surface 106 onto a display screen (not shown).

The first projection focusing group 108, as represented in FIG. 1, comprises a rear projection focusing lens 120, an intermediate projection focusing lens 122 and a front projection focusing lens 124 as an illustration. Although the projection focusing group 108 is described in connection with lenses 120, 122 and 124 as shown in FIG. 1, there is no requirement that the projection focusing elements necessarily comprise the types or number of lenses shown, or that they comprise lenses at all. Any one or more of focusing elements 120, 122 or 124 could alternatively, without departing from the spirit of the invention, be implemented as fresnel lenses, for example, or as curved mirrors or other any of the numerous other devices or combination thereof known in the art of focusing light.

The second projection focusing group 110, as represented in FIG. 1, comprises a rear projection focusing lens 126 and a front projection focusing lens 128 as an illustration. Although the projection focusing group 110 is described in connection with lenses 126 and 128 as shown in FIG. 1, as with the illumination group 104 and the first projection group 108, there is no requirement that the projection focusing elements necessarily comprise the types of, or number of, focusing devices shown in FIG. 1.

The illumination group 104 and projection groups 108 and 110 employed in this invention each incorporate at least one lens having a common design and manufacture with the other group. In other words, at least one lens in the projection groups 108 and 110 has the identical design as at least one lens in the illumination group 104. In the embodiment shown in FIG. 1, for example, the illumination group 104 and first projection group 108 are designed to use lenses of the same manufacture, although this is only one particular embodiment of the numerous combinations possible in accordance with the present invention.

The primary advantage of this design is the cost savings associated with it. As noted above, this invention makes use, in the illumination group 104, of parts that would otherwise be scrapped, or would require rework to be used in either of the projection groups 108 or 110.

In any manufacturing process, the cost of a part generally increases as the acceptable tolerances for that part are tightened. The increased cost can result, for example, from a lower yield of conforming parts from a given process. As tolerances are tightened, it is intuitive that fewer parts will fall within those tolerances and be considered conforming parts. Non-conforming parts are either scrapped or reworked, either of which adds to the final cost of the conforming parts. In order to increase yield, better manufacturing methods can be employed, but more consistent manufacturing processes are generally more expensive, thus increasing costs nonetheless.

The fact that this design uses one or more common lenses between the illumination group 104 and projection groups 108 and 110 means that significant costs can be saved in the manufacture of the lenses. The reason for this is that, as discussed above, the purpose of the illumination group 104 is to provide a uniform level of illumination to the object surface 106. The tolerances necessary to perform this task are much looser than the tolerances necessary to project a clear, focused and uniform image on a projection screen.

In the embodiment shown in FIG. 1, lenses 114, 116 and 118 are identical in manufacture to lenses 124, 122 and 120, respectively. Lenses 124, 122 and 120 would be taken from a group of lenses selected due to conformance with a tighter set of tolerances than those met by lenses 114, 116 and 118. This illustration should not be interpreted as limiting the invention, however. In some embodiments, the illumination group 104 and projection groups 108 and 110 share only one or two focusing elements rather than a complete focusing group.

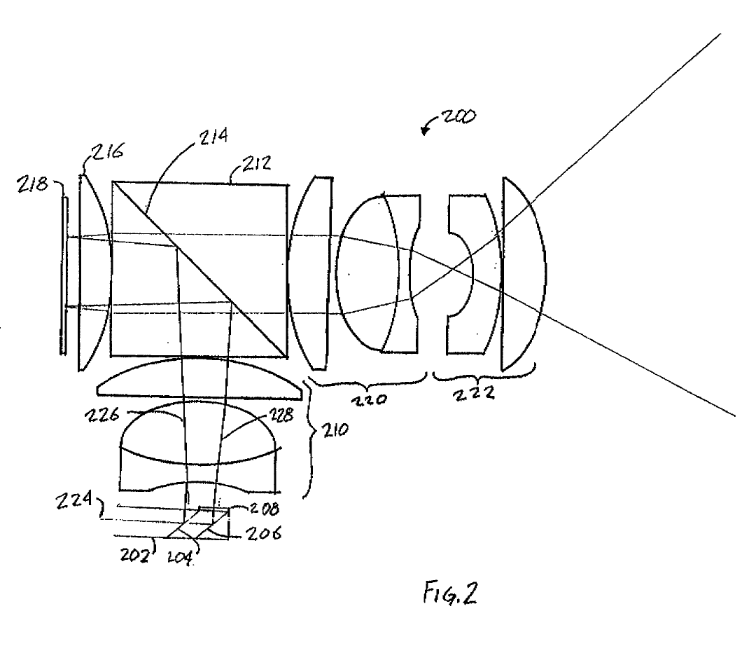

A second embodiment of the invention, comprising a projection device 200, is shown in FIG. 2. Projection device 200 comprises a light source 202 supplying light, represented by light ray 224, to a first polarizing group comprising elements 204, 206 and 208.

In this embodiment, the polarizing group comprises a polarized half mirror 204 oriented to reflect one polarized component 226 of each light ray 224 into the illumination group 210. The polarized half mirror 204 is designed to pass light having one polarity while reflecting light having a polarity orthogonal to the polarity passed. All polarized components 226 passing into the illumination group 210 have a uniform polarization. An orthogonal component 228 of each light ray 224 passes through the half mirror 204 and strikes the full mirror 206, which is oriented to reflect the orthogonally polarized light 206 through the half wave plate 208 into the illumination group 210. The full mirror 206 could alternatively be a polarized mirror having a polarity orthogonal to the half mirror 204, with essentially the same effect.

The half wave plate 208, the design of which is well known in the art of optics, is constructed to rotate the polarity of the light rays 228 by 90 degrees as they pass through it. It can be seen, then, that after passing through the half wave plate 208, light ray 228 will be polarized in the same orientation as light ray 226, so that all of the light passing into illumination group 210 is polarized with the same orientation. This is but one illustrative embodiment of a polarizing device. Any of a number of polarizing devices well known in the art could be employed for this function with successful results.

Polarized light passes through the illumination group 210 and into the prism block 212, where it is reflected by the polarized half mirror 214 onto, for example, a field lens 216 and liquid crystal display 218. It should be appreciated that illumination of image surfaces other than liquid crystal displays (e.g., photographs, slides, samples, etc.) may be imaged. The polarized half mirror 214 is designed to pass light having one polarity while reflecting light having a polarity orthogonal to the polarity passed. The polarized half mirror 214 shown in FIG. 2 is designed and oriented to reflect the light polarized by the polarizing elements 204, 206 and 208. Liquid crystal display 218 holds the image that is to be projected onto the projection screen. Liquid crystal display 218 rotates the polarization of the light by 90 degrees and reflects the light back through the field lens 216 back into the prism block 212. The light, now having a polarity orthogonal to its earlier orientation, passes through the polarized half mirror 214, out of the prism block 212 and into the first projection focusing group 220. The light passes through the first projection focusing group 220 and second projection focusing group 222, which together focus and expand the image onto a projection screen (not shown).

The illumination group 210 and projection groups 220 and 222 employed in this embodiment each incorporate at least one lens having a common design and manufacture as at least one lens in the other group. In other words, at least one lens in the projection groups 220 and 222 has the identical design as at least one lens in the illumination group 210. In the embodiment shown in FIG. 2, the illumination group 210 and first projection group 220 are designed to use lenses of the same manufacture, although this is only one particular embodiment of the numerous combinations possible in accordance with the present invention.

As with the embodiment shown in FIG. 1, the primary advantage of this design is the cost savings associated with it. As noted above, this invention makes use, in the illumination group 210, of parts that would otherwise be scrapped, or would require rework to be used in either of the projection groups 220 or 222.

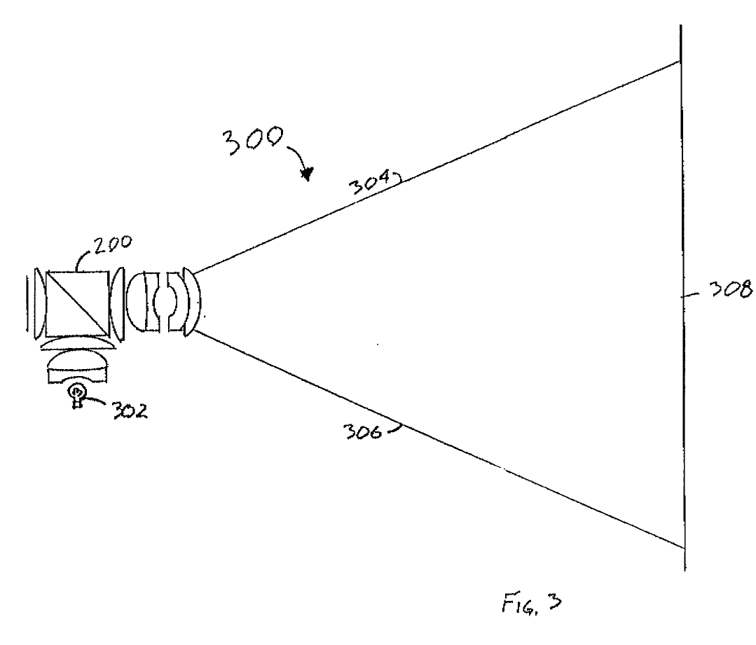

A full projection system, generally designated 300, is shown in FIG. 3. The projection system 300 comprises a light source 302 providing light to a projection unit 200 similar to that described in FIG. 2. The projection unit 200 projects an image onto a projection surface 308. The scale of the image on the projection surface 308 is generally considerably larger than the source image on the object surface. The outside edges 304 and 306 of the light pattern projected onto the projection surface diverge so as to expand the scale of the projected image. In certain embodiments, the size of the image displayed on the projection surface 308 is adjusted by moving the projection unit 200 closer or further away from the projection surface 308.

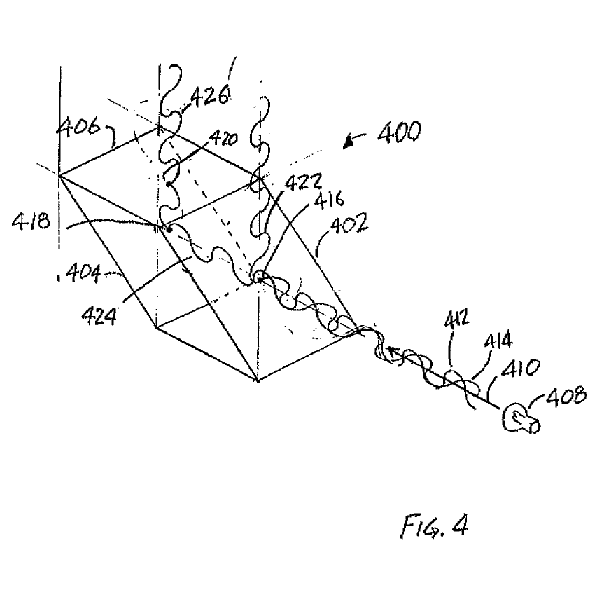

A compact polarizer of the type used in the present invention is shown in FIG. 4 and generally designated 400. Polarizer 400 comprises a polarized half mirror 402, a full mirror 404, and a half-wave plate 406. Light from a light source, such as aperture lamp 408 is emitted with a random polarization. Each ray of light such as ray 410 has both a vertical component 412 and a horizontal component 414. The following discussion focuses on the path of a single light ray for clarity, but it is well known in the art that light source such as lamp 408 emits a plurality of light rays traveling in a multitude of polarizations.

The magnitude of the two polarization components 412 and 414 is related to the polarization and amplitude of the ray 410. Ray 410 travels from the lamp 408 to the polarized half mirror 402 where it impinges thereon at point 416. Polarized half mirror 402 is transparent to the vertically polarized component 412 and reflective to the horizontally polarized component 414 of each light ray 410. The reflected horizontal component is designated 422 in FIG. 4. In the preferred embodiment, the polarized half mirror 402 is disposed at an angle of approximately 45 degrees from a vector connecting the lamp 410 to the center point 416 of the half mirror 402, so as to reflect most of the light received from lamp 408 at an approximately 90 degree angle. In an alternate embodiment, the polarized half mirror 402 could be designed to reflect the vertical component 412 and pass the horizontal component 414 without departing from the spirit of the invention.

Assuming a random, uniform distribution of polarization, reflected component 422 will comprise approximately one half of the light emitted from lamp 408. The remaining portion of the light passes through the polarized half mirror 402 to the full mirror 404. The light 424 impinging on the full mirror 404 represents the vertically polarized component of light ray 410. The vertical component 424 impinges on the full mirror 404 at point 418 and is reflected into the half wave plate 406. The vertical component 424 impinges on the half wave plate 406 at point 420. The half wave plate 406 rotates the polarization of the vertical component 424 by 90 degrees, so that, after passing through the half wave plate, the rotated component 426 has the same polarization as reflected component 422. It will be apparent to one of skill in the art that, through the use of this polarizer, nearly 100% of the light can be uniformly polarized, with minimum losses along the light path.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto.

The embodiments of an invention in which an exclusive property or right is claimed are defined as follows:

1. An image projection device comprising:
an illumination focusing group focusing light;
an object surface having an image thereon receiving focused light from the illumination focusing group; and
a projection lens group receiving light from the object surface and focusing the image, wherein at least part of the illumination focusing group and projection focusing group are of the same design and manufacture.

2. The image projection device of claim 1 further comprising a polarizer and wherein the object surface is a liquid crystal display panel.

3. The image projection device of claim 1 wherein the illumination lens group is designed to provide telecentric illumination at the image surface from a non-uniform source of light.

4. The image projection device of claim 1 further comprising an aperture lamp providing light to the illumination lens group.

5. The image projection device of claim 1 wherein the object surface comprises a photographic slide.

6. The image projection device of claim 1 further comprising a light source and a fiber optic transmission line connecting the light source to the illumination lens group.

7. A liquid crystal display projection device comprising:
a liquid crystal display panel;
an illumination focusing group disposed between a light source and the liquid crystal display panel;
a polarizer disposed between the light source and the liquid crystal display panel;
a first projection focusing group disposed opposite the light source from the liquid crystal display; and
a second projection focusing group disposed between the liquid crystal display and the first projection focusing group, wherein the first illumination focusing group and second projection focusing group are of the same design and manufacture.

8. The liquid crystal display projection device of claim 7 wherein the illumination focusing group is designed to provide telecentric illumination from a non-uniform source of light.

9. The liquid crystal display projection device of claim 7 further comprising an aperture lamp.

10. The liquid crystal display device of claim 7 further comprising a light source and fiber optic transmission line between the light source and the illumination projection group.

11. The projection device of claim 7 wherein the second projection group and the illumination group each comprise a set of three lenses.

12. The liquid crystal display projection device of claim 1 further comprising a light pipe providing light to the illumination focusing group.

13. The projection device of claim 7 wherein the illumination focusing group, object surface, and first and second projection focusing groups are disposed in a substantially linear orientation.

14. A liquid crystal display projection device comprising:
an illumination lens group;
a first polarizing device disposed adjacent to the illumination lens group so as to polarize any light passing through the illumination lens group;
a polarized reflecting device disposed so as to reflect polarized light from the illumination lenses onto a liquid crystal display panel;
a reflective liquid crystal display panel, having an image disposed thereon, disposed so as to reflect light back to the polarized reflecting device;
a second polarizing device modifying the polarization of the light reflected back to the polarized reflecting device so that the reflected light will pass through the polarized reflecting device;
a rear projection lens group; and
a front projection lens group;
wherein the illumination lens group and rear projection lens group are of the same design.

15. The liquid crystal display device of claim 14 wherein the first polarizing device is a polarized mirror disposed so as to reflect half of the light from the light source into the illumination lenses and further comprising a full mirror and half wave plate behind the polarized mirror disposed to repolarize the light passing through the polarized mirror and reflect it into the illumination lens group.

16. The liquid crystal display device of claim 15 wherein the set of illumination lenses provides telecentric illumination at the face of the liquid crystal display panel.

17. The liquid crystal display device of claim 14 wherein the first polarizing device is a polarized mirror disposed so as to reflect half of the light from the light source into a half wave plate and then into the illumination lenses and further comprising a full mirror behind the polarized mirror disposed to reflect the light passing through the polarized mirror into the illumination lens group.

18. The liquid crystal display device of claim 17 wherein the set of illumination lenses provides telecentric illumination at the face of the liquid crystal display panel.

19. The projection device of claim 14 further comprising a light source and a housing.

20. The projection device of claim 19 wherein the light source is an aperture lamp.

21. A polarizer comprising:
a polarized half mirror oriented so as to reflect a first polarization component of the light from a light source along a first vector and to pass a second polarization component having a polarization orthogonal to the first polarization component;
a mirror disposed behind the polarized half mirror to receive the second polarization component and oriented so as to reflect the second polarization component along a second vector parallel to the first vector; and
a half wave plate disposed to receive the second polarization component along the second vector and oriented to rotate the polarization of the second polarization component to a polarization parallel to that of the first polarization component.
